(19) United States
(12) Patent Application Publication
(10) Pub. No.: US 2023/0360557 A1
(43) Pub. Date: Nov. 9, 2023

(54) ARTIFICIAL INTELLIGENCE-BASED VIDEO AND AUDIO ASSESSMENT

(71) Applicant: Tabtu Corp, Kirkland, WA (US)

(72) Inventors: Anilkumar Balakrishnan, Bellevue, WA (US); Ramakrishnan Peruvemba, Bellevue, WA (US); Milan Kumar, Noida (IN); Sujith Kumar, Sutton (GB)

(21) Appl. No.: 17/740,209

(22) Filed: May 9, 2022

(51) Int. Cl. G09B 19/04; G06V 10/77; G06F 40/30; G06V 10/82; G06N 20/10

(52) U.S. Cl. CPC G09B 19/04; G06V 10/7715; G06F 40/30; G06V 10/82; G06N 20/10

(57) ABSTRACT

A computer system implements an artificial intelligence (AI) based assessment engine. In a video assessment process, the computer system receives video input including video of a human learner; extracts video features from the video input using tasks such as action detection, emotion detection, role identification, posture detection, head pose detection, person detection, or person identification. In an audio assessment process, the computer system receives audio input; feeds the audio input to a context-aware NLP processing engine; and extracts features from the audio input such as fluency score, pronunciation score, grammar score, coherence score, vocabulary score, sentiment score, or a combination thereof. The computer system obtains one or more automated scores from an AI scoring engine based on the extracted features and a scoring rubric previously learned by the AI scoring engine.

### BACKGROUND

In the coaching or assessment field, an expert human evaluator is typically required to score the candidates or learners being assessed. These human evaluators often need to be highly skilled or certified in respective domain, which may involve years of experience in the field, rigorous training, and testing. For assessments that involve evaluations of different skills or attributes, individual evaluation tasks may require separate evaluators as well. And, skilled human evaluators are nevertheless fallible, and may introduce errors, biases, and inconsistencies into a scoring system.

Such systems suffer from scalability issues and often require extended time frames to get final scores. In addition, when a system needs a change in its evaluation criteria or if new tasks/skills are added to the evaluation rubric, those changes must be propagated to all evaluators through additional training, which introduces added costs and latency, often on the order of months.

Some systems attempt to automate or digitize some aspects of the coaching or assessment process. In multimodal systems, computer vision and natural language processing models are trained together on datasets to learn a combined embedding space, or a space occupied by variables representing specific features of the images, text, and other media. Some multimodal systems pick up on biases in datasets, which may require monitoring by a human evaluator. Yet, as the description above suggests, human evaluators can introduce their own problems when it comes to monitoring of an automated assessment system.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In one aspect, a computer system receives video input including video of a human learner; feeds the video input to a video analysis engine; uses the video analysis engine to extract video features from the video input based on output of video assessment tasks including person detection, person identification, action detection, and emotion detection; feeds the extracted video features to an artificial intelligence (AI) scoring engine implementing a multi-task learning neural network; and obtains an automated score for the video input from the artificial intelligence scoring engine. The automated score is based on the extracted video features and a scoring rubric that has been previously learned by the artificial intelligence scoring engine.

In some embodiments, the method further comprises receiving voice input from the human learner and feeding the voice input to a context-aware natural language processing engine. In an embodiment, the computer system uses the context-aware natural language processing engine to perform a role detection task on the voice input. In other embodiments, the computer system uses the context-aware natural language processing engine to extract features from the voice input including one or more of sentiment score, fluency score, pronunciation score, grammar score, coherence score, and vocabulary score; feeds features extracted from the voice input to an artificial intelligence scoring engine; and obtains an automated score for the voice input from the artificial intelligence scoring engine. In such embodiments, the automated score is based on the extracted features and a scoring rubric that has been previously learned by the artificial intelligence scoring engine, which may include a reinforcement learning agent. In an embodiment, the reinforcement learning agent uses a Q-learning algorithm. In an embodiment, calculation of the vocabulary score comprises using term frequency-inverse document frequency (TF-IDF) analysis. In an embodiment, calculation of the pronunciation score comprises using a goodness of pronunciation (GOP) algorithm in combination with a linear support vector machine (SVM). In an embodiment, calculation of the grammar score comprises comparing raw text with grammar corrected text and identifying differences between the raw text and the grammar corrected text.

In some embodiments, the method further comprises performing topic extraction on the voice input and performing polarity analysis on the voice input. The computer system may analyze the results of the topic extraction and the polarity analysis in combination with the coherence score to measure connectedness between sentences in the voice input. The calculation of the coherence score may include using distribution of cosine similarity between sentences.

In another aspect, a computer system receives voice input; feeds the voice input to a context-aware natural language processing engine; uses the context-aware natural language processing engine to extract features from the voice input; feeds the extracted features to an artificial intelligence scoring engine; and obtains an automated score for the voice input from the artificial intelligence scoring engine. The extracted features including fluency score, pronunciation score, grammar score, coherence score, and vocabulary score. The automated score is based on the extracted features and a scoring rubric that has been previously learned by the artificial intelligence scoring engine. In an embodiment, the artificial intelligence scoring engine includes a reinforcement learning agent and maps the extracted features into the scoring rubric with dynamic weight adjustment using a deep neural network with reinforcement learning.

In some embodiments, the computer system also receives video input including video of a human learner; feeds the video input to a video analysis engine; uses the video analysis engine to extract video features from the video input; feeds the extracted video features to the artificial intelligence scoring engine; and obtains a second automated score for the video input from the artificial intelligence scoring engine. The extracted video features are based on output from one or more of the following tasks: emotion detection, posture detection, action detection, head pose detection, role identification. The second automated score is based on the extracted video features and a second scoring rubric that has been previously learned by the artificial intelligence scoring engine.

In some embodiments, the context-aware natural language processing engine is used to extract other combinations of features from the voice input, such as fluency score, pronunciation score, grammar score, and coherence score, while omitting a vocabulary score. Many other combinations of extracted voice input features are possible.

Illustrative computer systems are also described.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a block diagram of a computer system in which described embodiments may be implemented;

FIG. 2 is a flow chart of an illustrative process for obtaining automated scores from an AI scoring engine based on extracted features and a scoring rubric learned by the AI scoring engine, in accordance with embodiments described herein;

FIGS. 3, 4, and 5, are illustrative screenshot diagrams showing examples of user interfaces that may be used in accordance with described embodiments; and

FIG. 6 is a block diagram that illustrates aspects of an illustrative computing device appropriate for use in accordance with embodiments of the present disclosure.

### DETAILED DESCRIPTION

Embodiments described herein relate to a platform for multimodal (e.g., audio and video-based) artificial intelligence-based coaching and assessment. Described embodiments use combinations of deep learning, computer vision, and natural language processing techniques that may be applied in different coaching and assessment tasks, such as evaluating so-called “soft” interpersonal or communication skills for a student or job candidate in a field in which such skills are highly sought after, such as medicine, counseling, teaching, management, or sales, among others.

Some systems attempt to automate or digitize some aspects of the coaching or assessment process. In multimodal systems, computer vision and natural language processing models are trained together on datasets to learn a combined embedding space, or a space occupied by variables representing specific features of the images, text, and other media. Some multimodal systems pick up on biases in datasets, which may require monitoring by a human evaluator. Yet, human evaluators can introduce their own problems when it comes to monitoring of an automated assessment system.

Described embodiments provide technical solutions for such problems with an automatic AI-based assessment solution. Such embodiments are highly scalable, available, robust, and less prone to inconsistency and biases that other automated systems, and may avoid the need for any human evaluator. Described embodiments also provide insights into performance of the candidate in individual skills or components of skills, which may provide greater ability to explain scoring results than other automatic systems or even human evaluators.

Described embodiments include speech assessment modules, video assessment modules, or combinations thereof. In some embodiments, speech assessment includes automated assessment of speech input to assess aspects such as sentiment, pronunciation, grammar, fluency, vocabulary, and coherence. In some embodiments, video assessment includes automated assessment of video input perform tasks such as person detection, person identification, role identification, action recognition, and emotion recognition.

In embodiments described herein, a computer system provides automated AI-based analysis of audio input, video input, or a combination thereof to evaluate human learners. In one illustrative approach, a computer system receives video input including video of the human learner (e.g., in a training or evaluation exercise); feeds the video input to a video analysis engine; uses the video analysis engine to extract video features from the video input using tasks such as person detection, person identification, action detection, and emotion detection; feeds the extracted video features to an artificial intelligence (AI) scoring engine implementing a multi-task learning neural network; and automatically obtains a score for the video input from the artificial intelligence scoring engine. The score is based on the extracted video features and a scoring rubric that has been previously learned by the AI scoring engine.

In some embodiments, the computer system receives and processes voice input. Processing of voice input can be done independently from video assessment, or as an extension to video assessment. In an illustrative approach, the computer system receives voice input from the human learner; feeds the voice input to a context-aware natural language processing (NLP) engine; uses the context-aware NLP engine to extract role detection features from the voice input; and feeds the extracted role detection features to the AI scoring engine. As further extensions, the computer system can use the context-aware NLP engine to extract features from the voice input such as a fluency score, pronunciation score, grammar score, coherence score, vocabulary score, or a combination thereof; feed the extracted features to an AI scoring engine; and automatically obtaining a score for the voice input from the AI scoring engine. In such a scenario, the score (which may be provided as a combined score with video assessment scoring, or as an independent speech assessment score) is based on the extracted features and a scoring rubric that has been previously learned by the AI scoring engine. The details of the scoring rubric can be adjusted in any way that suits the assessment, evaluation, or scoring that is taking place, as the system includes the ability to re-learn and apply adjusted rubrics as needed.

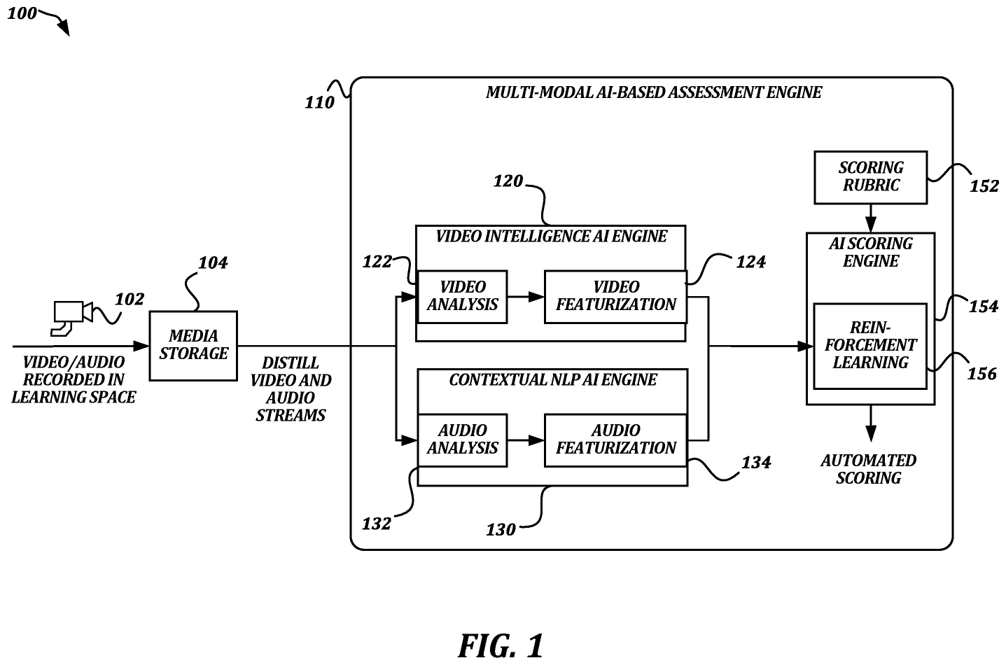

FIG. 1 is a block diagram of a computer system in which described embodiments may be implemented. The system 100 includes one or more video or audio recording devices 102 (e.g., stand-alone digital cameras or microphones, or devices having integrated cameras or microphones such as a smart phone or tablet computer), a media storage device 104, and a multi-modal AI-based assessment engine 110, which may be implemented by one or more computing devices, such as server computers.

In the example shown in FIG. 1, the recording devices 102 record media data (e.g., video data or audio data) in a learning or training space. This may include a physical space in which human learners are present, a virtual reality space accessed by users (e.g., learners, trainees, or coaches) with virtual reality devices such as virtual reality headsets, an augmented reality space, or some other arrangement. The recorded media data may be stored long-term or temporarily in media storage 104. The media data is then distilled into video and audio streams. Alternatively, such as in situations where only video or only audio data is used, the distillation process may be omitted.

The media streams are sent to the multi-modal AI-based assessment engine 110 for processing. In the example shown in FIG. 1, a video intelligence AI engine 120 is provided for processing video data, and a contextual NLP engine 130 is provided for processing audio data. In the video intelligence AI engine, video streams are analyzed in the video analysis module 122, which may perform tasks such as pose detection, face mesh processing, object detection, person identification, action detection, or the like, as described in further detail below. The output of video analysis module 122 is provided to video featurization module 124 for feature extraction. In the contextual NLP AI engine 130, audio streams are analyzed in the audio analysis module 132, which may include speech recognition, language modeling, acoustic modeling, or other tasks. The output of audio analysis module 132 is provided to audio featurization module 134 for feature extraction. In some embodiments, the extracted features include role detection, fluency score, pronunciation score, grammar score, coherence score, vocabulary score, sentiment score, or other features or combinations of features, as described in further detail below.

The output of the video featurization module 124 and the audio featurization module 134 is provided to AI scoring engine 154, which has previously learned a scoring rubric 152. In some embodiments, the AI scoring engine 154 applies weights to the extracted features, and the particular weighting that is to be applied is learned by the AI scoring engine using reinforcement learning 156. The AI scoring engine 154 generates one or more automated scores based on the extracted video features, the extracted audio features, or a combination thereof, as well as the scoring rubric 152. The AI scoring engine 154 uses the reinforcement learning 156 to adjust weights over time, which improves the accuracy of predicted scores that converge to scores assigned by human graders trained in the rubric 152. In some embodiments, a Q-learning approach is used, which enables a reinforcement learning agent to use feedback from the environment to learn the best actions it can take (e.g., the most accurate scoring, given the scoring rubric) in different circumstances.

Many alternatives to the arrangement shown in FIG. 1 are possible. For example, although the system 100 includes modules in which both video and audio data are processed, it should be understood that the system can be altered for usage scenarios in which only audio or only video are processed. As another example, although only one scoring rubric is shown for ease of illustration, the system 100 can be extended to accommodate multiple scoring rubrics, such as separate rubrics for audio assessment and video assessment, or for scoring of different skills, or for scoring similar skills using different criteria, e.g., by different organizations or different work groups within an organization.

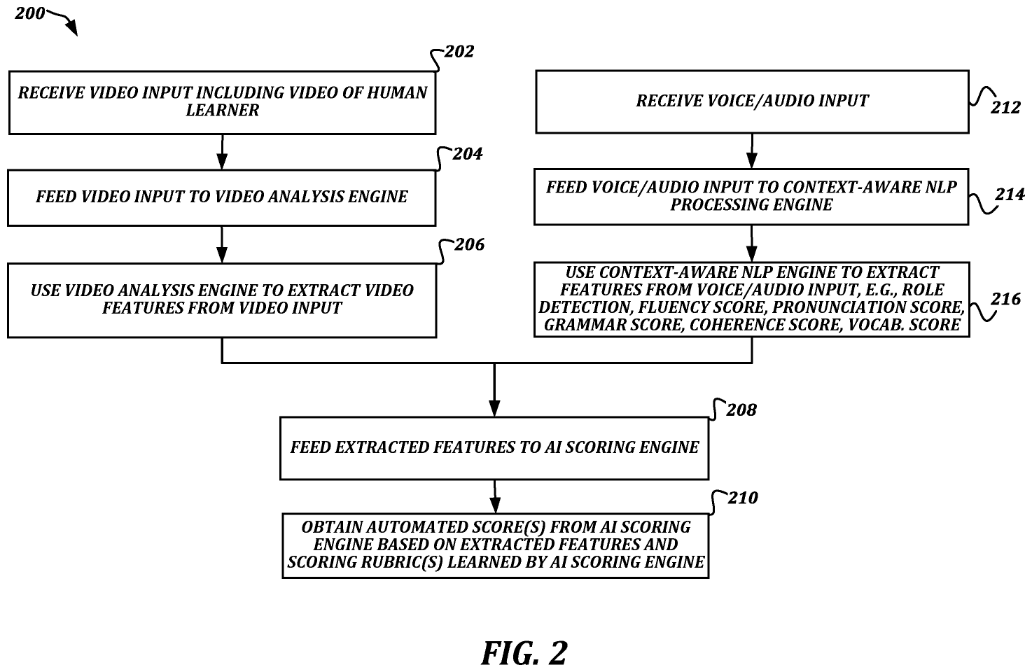

FIG. 2 is a flow chart of an illustrative process for obtaining automated scores from an AI scoring engine based on extracted features and a scoring rubric learned by the AI scoring engine, in accordance with embodiments described herein. The process 200 may be performed by a computer system such as a server computer system that implements an AI-based assessment engine such as the multi-modal AI-based assessment engine 110, or some other system.

In the example shown in FIG. 2, the process 200 includes a video assessment process (process blocks 202, 204, 206) and an audio assessment process (process blocks 212, 214, 216). The video assessment process and the audio assessment process may be used independently or in combination. Turning first to the video assessment process, at process block 202 the computer system receives video input including video of a human learner. At process block 204, the computer system feeds the video input to a video analysis engine. At process block 206, the computer system uses the video analysis engine to extract video features from the video input. The extraction of these features may be performed using techniques such as object detection and tracking, posture detection, head pose detection, person detection, person identification, face detection, action detection, emotion detection, role identification, or a combination thereof.

Turning now to the audio assessment process, at process block 212 the computer system receives audio input including speech of the human learner. At process block 214, the computer system feeds the audio input to a context-aware NLP processing engine. At process block 216, the computer system uses the context-aware NLP processing engine to extract features from the audio input, such as role detection, fluency score, pronunciation score, grammar score, coherence score, vocabulary score, sentiment score, or a combination thereof.

At process block 208, the computer system feeds the extracted video or voice/speech features to an AI scoring engine. In some embodiments, the AI scoring engine includes a reinforcement learning agent, which may use a Q-learning algorithm. In some embodiments, the AI scoring engine maps the extracted features into the scoring rubric with dynamic weight adjustment, using a deep neural network with reinforcement learning. At process block 210, the computer system obtains one or more automated scores from the AI scoring engine based on the extracted features and one or more scoring rubrics learned by the AI scoring engine.

Illustrative approaches for speech assessment and video assessment will now be described.

Speech Assessment Techniques

As explained above, described embodiments perform speech assessment tasks on audio input. In some embodiments, speech assessment includes extraction of features from voice input such as a fluency score, a pronunciation score, a grammar score, a coherence score, and a vocabulary score. Illustrative approaches for assessing these features are described below.

Pronunciation

An illustrative approach to pronunciation assessment is now described.

Typical pronunciation evaluation systems use a Goodness of Pronunciation (GOP) formula to estimate phoneme level pronunciation. As an advancement over such prior systems, described embodiments take GOP-based extracted features and feed them to a Linear Support Vector Machine (SVM), which is fine-tuned on human expert annotated non-native labelled data. This additional layer of processing improves pronunciation evaluation, significantly improving phoneme pronunciation classification accuracy. This design helps to avoid biases when evaluating non-native speakers, as most acoustic models used for GOP evaluation are trained on native speakers. This design allows accurate processing of native and non-native speech components, making it suitable for pronunciation evaluation across different accents.

In an embodiment, GOP features are extracted from a raw audio file using a speech processing toolkit such as the Kaldi toolkit. These extracted GOP base features are then fed to a machine-learning based model, which evaluates and tags individual phonemes as being correctly pronounced or not. The individual class prediction for phonemes is then normalized, and a final pronunciation score is calculated for the given task by the candidate.

In an embodiment, a trained Linear Kernel Support Vector Machine model predicts the class for each phoneme, which improves cross-correlation and correctness of pronunciation classification.

Grammar

An illustrative approach to grammar assessment is now described.

In an embodiment, a model for a grammar correction task is trained. The grammar correction task is formulated as sequence tagging, and a sequence tagging model is used. In an embodiment, the sequence tagging model is an encoder that is pretrained and stacked with two linear layers with softmax layers on the top, with cased pretrained transformers, Byte-Pair Encoding (BPE) tokenization, and a pre-trained transformer architecture similar to that described in Liu et al., “RoBERTa: A Robustly Optimized BERT Pretraining Approach,” arXiv:1907.11692 (July 2019). In an embodiment, to process the information at the token-level, we take the first subword per token from the encoder's representation, which is then forwarded to subsequent linear layers, which are responsible for error detection and error tagging, respectively.

In an embodiment, text correction is performed according an approach similar to that described in Omelianchuk et al., “GECToR—Grammatical Error Correction: Tag, Not Rewrite,” arXiv:2005.12592v2 (May 2020). In this approach, to correct the text, for each input token from a source sequence, the tag-encoded token-level transformation T(xi) is predicted, where T(xi) represents transformations, token-level edit operations, such as: keep the current token unchanged, delete current token, append new token t1 next to the current token xi, or replace the current token xi with another token t2. These predicted tag-encoded transformations are then applied to the sentence to get the modified sentence. Three training stages are used, including pre-training on synthetic errorful sentences, fine-tuning on errorful-only sentences, and fine-tuning on a subset of errorful and error-free sentences.

In an embodiment, during inference, the model is fed input, possibly grammatically incorrect text, and in response we get grammar corrected text along with a count of token transformations made in the input text. We then calculate Levenshtein distance between input text and output text from the model. Both the scores (model prediction and Levenshtein distance) are then normalized and then added with uniform weight to get the final “Grammar Score” for that given task.

In an embodiment, a novel formula for calculating final “Grammar Score” is used, which is a combination of Levenshtein distance and model prediction token transformation count, with uniform weight, as follows:

Grammar Score=(0.5*model prediction token transformation count)+(0.5*Levenshtein distance)

This approach produces accurate results and high correlation with human evaluators.

Fluency

An illustrative approach to fluency assessment is now described.

In an embodiment, fluency is evaluated using a trained Support Vector Machine (SVM) based classifier model, which classifies a task audio file in terms of speech fluency using an annotated dataset to train the model. We extract Mel-frequency cepstral coefficients (MFCCs), root-mean-square energy (RMSE), Spectral flux, Zero-crossing rate (ZCR) from raw audio input, and stack them together to form input to the trained SVM model. In an embodiment, the fluency class predicted by the model is one of three values representing “High” fluency, “Intermediate” fluency, or “Low” fluency.

### Vocabulary

An illustrative approach to vocabulary assessment is now described.

In an embodiment, vocabulary scoring is performed based on statistical formulations including average word length, normalized word count with over two syllables, moving average type token ratio, or a normalized word frequency score using a frequent words corpus. In an embodiment, a vocabulary score is expressed as a weighted average of a combination of such formulations. In some embodiments, calculation of the vocabulary score comprises using term frequency-inverse document frequency (TF-IDF) analysis.

Coherence

An illustrative approach to coherence assessment is now described.

Presently, coherence evaluation in a paragraph or dialog text remains an unsolved problem, with existing solutions producing inferior performance. Some existing solutions are based on statistical models. Other systems use word level features as a base component, along with manual feature engineering for coherence evaluation, which presents an inferior approach, as word level features do not consider context information in the sentence and hence lose a lot of information. Systems that require fine tuning of model in the target domain to give plausible results, using annotation of data by a human evaluator, are problematic in terms of scalability and efficiency.

Accordingly, in some embodiments, deep learning-based sentence level vectors are used. This approach preserves context and semantic meaning of the sentence, which provides consistent and meaningful results. In an embodiment, a coherence score is calculated using distribution of cosine similarity between adjacent sentences, without manual feature engineering or finetuning on domain specific data which needs to be labelled by human annotator. This improves scalability and efficiency while also having a positive correlation with human annotated scores in capturing coherence in texts.

The BERT language model can be used for speech processing as part of an overall process for calculating a score for coherence. (See, e.g., Devlin et al., “BERT: Pre-training of Deep Bidirectional Transformers for Language Understanding,” arXiv:1810.04805v2 (May 2019).

In some embodiments, the BERT model is fine-tuned for generating contextual vectors for sentences and trained using a Siamese network for sentence similarity tasks. A Siamese network uses two identical artificial neural networks to analyze the same input vector and compares their outputs afterwards. We then calculate cosine similarity between adjacent sentences using above mentioned model and then normalize the individual similarity scores to get the final coherence score for the task. This approach is helpful to capture systematic, logical connectivity and consistency in, say, a dialog between people in an evaluation or training exercise, or in an answer to a question.

In some embodiments, topic extraction and polarity analysis are performed on sentences in voice input, and the results of the topic extraction and the polarity analysis are analyzed in combination with the coherence score to measure connectedness between the sentences. In such embodiments, the calculation of the coherence score may include using distribution of cosine similarity between the sentences.

Video Assessment

As explained above, described embodiments perform video assessment tasks on video input, either independently or in combination with speech assessment tasks. In some embodiments, video assessment tasks include person detection, person identification, role identification, action recognition, and emotion recognition. A multi-task learning approach also can be used for such tasks.

In some embodiments, a multitask learning network neural architecture is used to analysis video input in which multiple tasks are being performed. Multitask learning is an approach to inductive transfer that improves generalization by using domain information contained in training signals of related tasks as an inductive bias. Tasks are learned in parallel while using a shared representation: output generated by common hidden layers. The learning for each task also can help other tasks be learned. (See Caruana, “Multitask Learning,” Machine Learning, Vol. 28, pp. 41-75 (1997).) The shared representation is input to a set of task-specific hidden layers that learn how to predict output for individual tasks.

In some embodiments, a multi-task learning neural network is used, with individual video assessment tasks being modelled using separate layers and output heads. Each task is trained with a task specific dataset and objective function. During inference, we get all task predictions simultaneously.

In an embodiment, we use a pre-trained machine-learning solution as backbone for extracting relevant human body key points, using the MediaPipe framework available from Google LLC. Extracted human body key points form the input to the multi-task neural network. We stack task specific layers for individual tasks (examples of which are described below) on top of these inputs and train them separately using task specific datasets and objective functions.

In an illustrative approach, human body analytics are performed using a single neural network as a multi-task learner. Using this approach, a single network can model illustrative tasks described herein simultaneously.

Illustrative approaches for particular video assessment tasks are described below.

Person Detection & Identification

Person detection is a specific form of object detection, which generally refers to identifying the presence of types of objects in an image. Person detection may involve both identifying the presence of the person in, say, a video frame, and identifying the location of that person in the frame.

In some embodiments, for multi-person detection, we use the MediaPipe framework in conjunction with YOLOvS object detection models, available from Ultralytics.com. For consistent person identification in continuous video stream/frame, we use the Deep SORT framework, which performs Kalman filtering in image space and frame-by-frame data association using the Hungarian method with an association metric that measures bounding box overlap. (See Wojke et al., “Simple Online and Realtime Tracking with a Deep Association Metric,” arXiv:1703.07402v1 (March 2017).)

Role Identification

Role identification is the process of identifying and assigning a role in a conversation transcript to the parties involved. It is important in a conversation corpus to assign spoken conversation turns to each role, as it forms the bases for further feature extraction. If done manually, it turns out to be a tedious process where a human would need to go through conversation data and infer and assign roles.

In described embodiments, an unsupervised automated role assignment solution is used, which applies deep learning to a conversation transcript. In an illustrative approach, we start with defining roles in plain English, e.g., for a Physician role, a definition such as “a health professional who practices medicine, which is concerned with promoting, maintaining or restoring health through the study, diagnosis, prognosis and treatment of disease, injury, and other physical and mental impairments.” Given this role definition, we calculate sentence embeddings (vectors of real numbers) for the role definition using the SentenceTransformers framework. (See Reimers et al., “Sentence-BERT: Sentence Embeddings using Siamese BERT-Networks,” arXiv:1908.10084v1 (August 2019).) Next, we calculate sentence embeddings for a speaker diarized conversation corpus, on a per-turn basis (per user utterance), for all speakers. Then, we calculate the mean of all sentence embeddings per speaker, to arrive at a single vector representing the speaker. We then calculate cosine similarity of role definition vector, with respect to all calculated speaker vector. The speaker vector with maximum value for cosine similarity with the role definition is then assigned the role.

This approach is unsupervised and scalable. With the role definition being supplied, roles can be automatically assigned to the speakers in the conversation.

Action Recognition

In some embodiments, the MediaPipe Pose machine learning solution, available from Google LLC, is used for high-fidelity body pose tracking, inferring 3D landmarks and background segmentation mask from RGB video frames. These landmarks are then used to train action recognition specific layers (fully connected feed forward layers) and corresponding output heads, as multi class classification problem, on a publicly available dataset.

Emotion Recognition

Emotion recognition is used to recognize from video or image input basic human emotional states, such as angry, disgusted, fearful, happy, sad, surprised, and neutral.

In some embodiments, a face mesh software solution is used to obtain face mesh data. In an embodiment, the face mesh software is the MediaPipe Face Mesh face geometry solution available from Google LLC. Face Mesh estimates 468 3D face landmarks in realtime. It employs machine learning to infer the 3D surface geometry, requiring only a single camera input without the need for a dedicated depth sensor.

Face landmarks are then fed to a feed forward neural network layer, which are specific to the Emotion Recognition task and are trained as a multi-class classification problem.

Illustrative User Interfaces

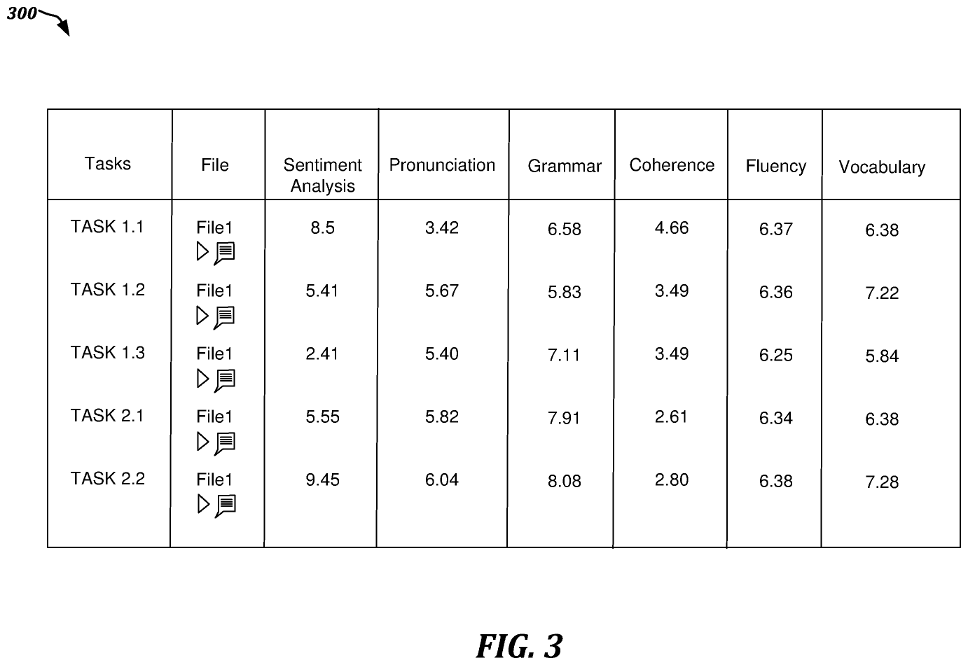

FIGS. 3, 4, and 5, are illustrative screenshot diagrams showing examples of user interfaces that may be used in accordance with described embodiments.

In the example shown in FIG. 3, the screenshot 300 depicts a user interface for reviewing results of analysis of audio input, in the form of speech assessment features for tasks performed by a human learner that is being evaluated. Tasks are represented in rows, with links to audio files on which the extracted features is based. The scores (features) associated with each task include sentiment analysis, pronunciation, grammar, coherence, fluency, and vocabulary. Users may also be given the option to perform additional actions such as reviewing automatically generated transcripts of the recorded audio or leave a comment.

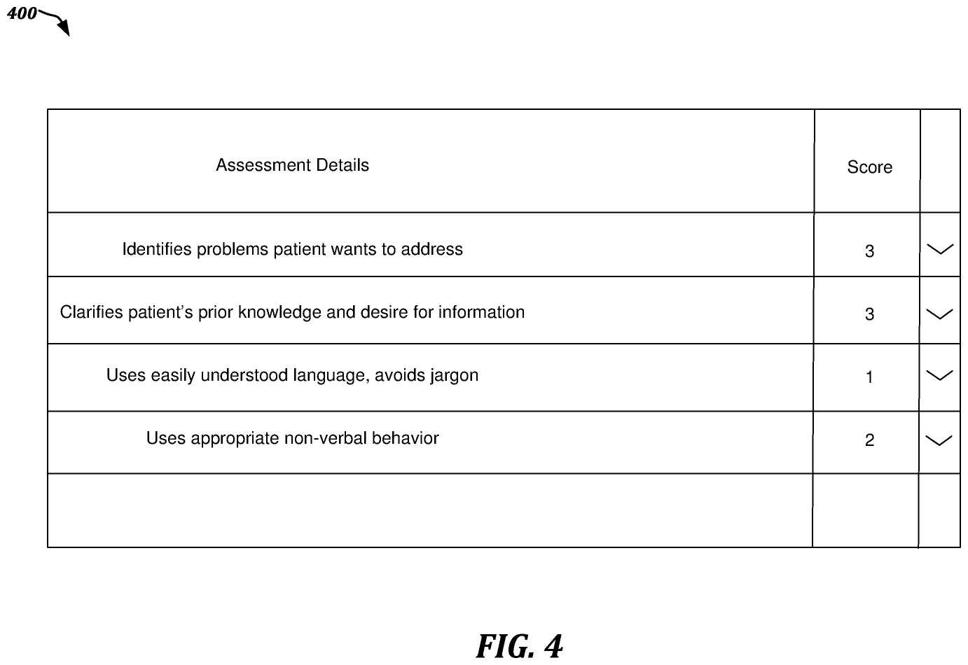

In the example shown in FIG. 4, the screenshot 400 depicts a user interface for reviewing automatically generated scoring for particular skills, as may be performed after completion of an assessment or evaluation exercise in which a human learner, such as a medical student, has participated. In this example, assessed skills include four different skills related to interactions with patients, with scores identified for each skill. Downward-pointing chevrons indicate an option to reveal further information about the scoring for each skill.

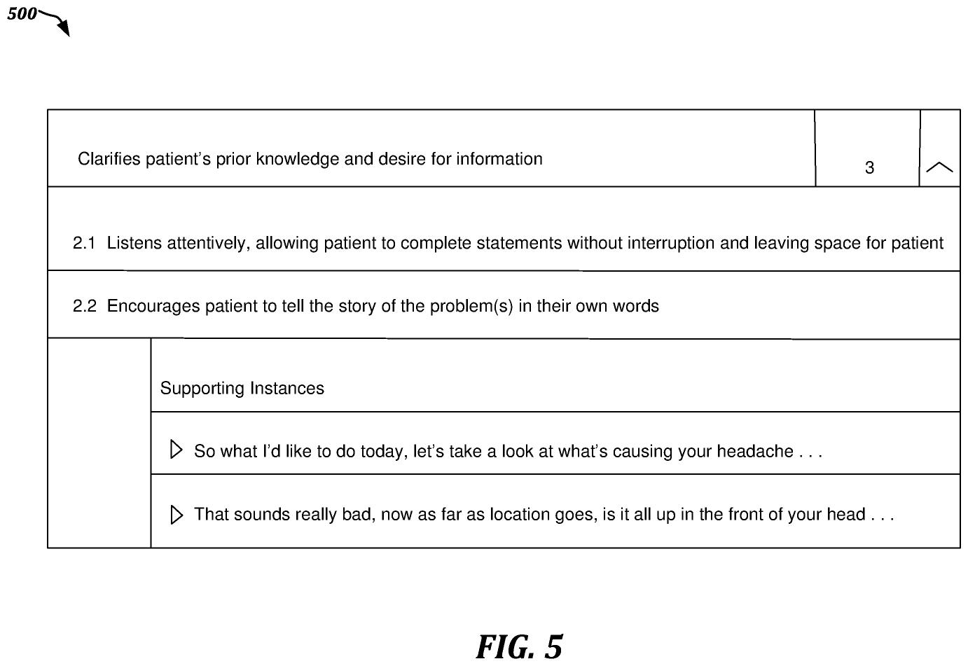

In the example shown in FIG. 5, the screenshot 500 depicts an update to the user interface shown in FIG. 4, in which more information is shown for the scoring of a particular skill. In this example, two subskills (2.1 and 2.2) are shown, with additional information in support of the analysis of subskill 2.2. This additional information includes supporting instances automatically identified by the system as being significant to the score result, based on the system's analysis of the audio input and its learning of the corresponding rubric. In FIG. 5, the system has identified at two sections of the speech input as being significant for the assessment of subskill 2.2, with “play” buttons provided to allow a user to review corresponding portions of the audio. These features enhance the ability of the system to explain or reveal how it is arriving at its scores.

Illustrative Operating Environments

Unless otherwise specified in the context of specific examples, described techniques and tools may be implemented by any suitable computing device or set of devices.

In any of the described examples, an engine may be used to perform actions. An engine includes logic (e.g., in the form of computer program code) configured to cause one or more computing devices to perform actions described herein as being associated with the engine. For example, a computing device can be specifically programmed to perform the actions by having installed therein a tangible computer-readable medium having computer-executable instructions stored thereon that, when executed by one or more processors of the computing device, cause the computing device to perform the actions. The particular engines described herein are included for ease of discussion, but many alternatives are possible. For example, actions described herein as associated with two or more engines on multiple devices may be performed by a single engine. As another example, actions described herein as associated with a single engine may be performed by two or more engines on the same device or on multiple devices.

In any of the described examples, a data store contains data as described herein and may be hosted, for example, by a database management system (DBMS) to allow a high level of data throughput between the data store and other components of a described system. The DBMS may also allow the data store to be reliably backed up and to maintain a high level of availability. For example, a data store may be accessed by other system components via a network, such as a private network in the vicinity of the system, a secured transmission channel over the public Internet, a combination of private and public networks, and the like. Instead of or in addition to a DBMS, a data store may include structured data stored as files in a traditional file system. Data stores may reside on computing devices that are part of or separate from components of systems described herein. Separate data stores may be combined into a single data store, or a single data store may be split into two or more separate data stores.

Some of the functionality described herein may be implemented in the context of a client-server relationship. In this context, server devices may include suitable computing devices configured to provide information and/or services described herein. Server devices may include any suitable computing devices, such as dedicated server devices. Server functionality provided by server devices may, in some cases, be provided by software (e.g., virtualized computing instances or application objects) executing on a computing device that is not a dedicated server device. The term “client” can be used to refer to a computing device that obtains information and/or accesses services provided by a server over a communication link. However, the designation of a particular device as a client device does not necessarily require the presence of a server. At various times, a single device may act as a server, a client, or both a server and a client, depending on context and configuration. Actual physical locations of clients and servers are not necessarily important, but the locations can be described as “local” for a client and “remote” for a server to illustrate a common usage scenario in which a client is receiving information provided by a server at a remote location. Alternatively, a peer-to-peer arrangement, or other models, can be used.

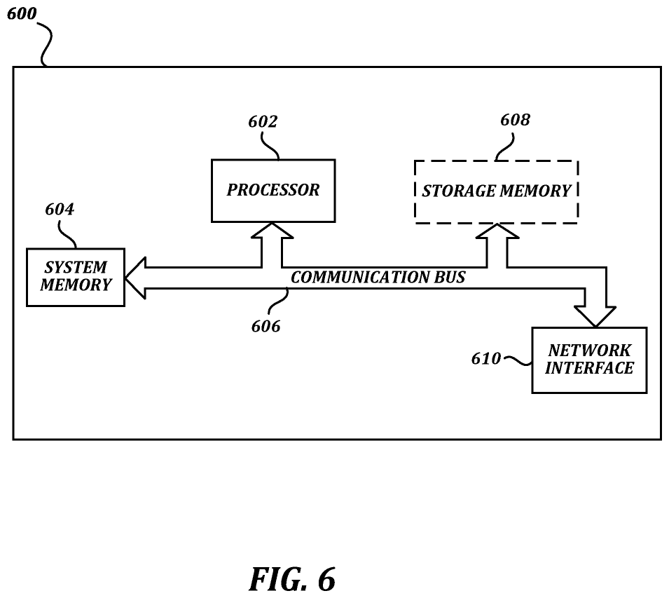

FIG. 6 is a block diagram that illustrates aspects of an illustrative computing device 600 appropriate for use in accordance with embodiments of the present disclosure. The description below is applicable to servers, personal computers, mobile phones, smart phones, tablet computers, embedded computing devices, and other currently available or yet-to-be-developed devices that may be used in accordance with embodiments of the present disclosure.

In its most basic configuration, the computing device 600 includes at least one processor 602 and a system memory 604 connected by a communication bus 606. Depending on the exact configuration and type of device, the system memory 604 may be volatile or nonvolatile memory, such as read only memory (“ROM”), random access memory (“RAM”), EEPROM, flash memory, or other memory technology. Those of ordinary skill in the art and others will recognize that system memory 604 typically stores data and/or program modules that are immediately accessible to and/or currently being operated on by the processor 602. In this regard, the processor 602 may serve as a computational center of the computing device 600 by supporting the execution of instructions.

As further illustrated in FIG. 6, the computing device 600 may include a network interface 610 comprising one or more components for communicating with other devices over a network. Embodiments of the present disclosure may access basic services that utilize the network interface 610 to perform communications using common network protocols. The network interface 610 may also include a wireless network interface configured to communicate via one or more wireless communication protocols, such as WiFi, 2G, 3G, 4G, LTE, 5G, WiMAX, Bluetooth, and/or the like.

In FIG. 6, the computing device 600 also includes a storage medium 608. However, services may be accessed using a computing device that does not include means for persisting data to a local storage medium. Therefore, the storage medium 608 depicted in FIG. 6 is optional. In any event, the storage medium 608 may be volatile or nonvolatile, removable or nonremovable, implemented using any technology capable of storing information such as, but not limited to, a hard drive, solid state drive, CD-ROM, DVD, or other disk storage, magnetic tape, magnetic disk storage, and/or the like.

As used herein, the term “computer-readable medium” includes volatile and nonvolatile and removable and nonremovable media implemented in any method or technology capable of storing information, such as computer-readable instructions, data structures, program modules, or other data. In this regard, the system memory 604 and storage medium 608 depicted in FIG. 6 are examples of computer-readable media.

For ease of illustration and because it is not important for an understanding of the claimed subject matter, FIG. 6 does not show some of the typical components of many computing devices. In this regard, the computing device 600 may include input devices, such as a keyboard, keypad, mouse, trackball, microphone, video camera, touchpad, touchscreen, electronic pen, stylus, and/or the like. Such input devices may be coupled to the computing device 600 by wired or wireless connections including RF, infrared, serial, parallel, Bluetooth, USB, or other suitable connection protocols using wireless or physical connections.

In any of the described examples, input data can be captured by input devices and processed, transmitted, or stored (e.g., for future processing). The processing may include encoding data streams, which can be subsequently decoded for presentation by output devices. Media data can be captured by multimedia input devices and stored by saving media data streams as files on a computer-readable storage medium (e.g., in memory or persistent storage on a client device, server, administrator device, or some other device). Input devices can be separate from and communicatively coupled to computing device 600 (e.g., a client device), or can be integral components of the computing device 600. In some embodiments, multiple input devices may be combined into a single, multifunction input device (e.g., a video camera with an integrated microphone). The computing device 400 may also include output devices such as a display, speakers, printer, etc. The output devices may include video output devices such as a display or touchscreen. The output devices also may include audio output devices such as external speakers or earphones. The output devices can be separate from and communicatively coupled to the computing device 600, or can be integral components of the computing device 600. Input functionality and output functionality may be integrated into the same input/output device (e.g., a touchscreen). Any suitable input device, output device, or combined input/output device either currently known or developed in the future may be used with described systems.

In general, functionality of computing devices described herein may be implemented in computing logic embodied in hardware or software instructions, which can be written in a programming language, such as C, C++, COBOL, JAVA™, PHP, Perl, Python, Ruby, HTML, CSS, JavaScript, VBScript, ASPX, Microsoft.NET™ languages such as C#, and/or the like. Computing logic may be compiled into executable programs or written in interpreted programming languages. Generally, functionality described herein can be implemented as logic modules that can be duplicated to provide greater processing capability, merged with other modules, or divided into sub-modules. The computing logic can be stored in any type of computer-readable medium (e.g., a non-transitory medium such as a memory or storage medium) or computer storage device and be stored on and executed by one or more general-purpose or special-purpose processors, thus creating a special-purpose computing device configured to provide functionality described herein.

Extensions and Alternatives

Many alternatives to the systems and devices described herein are possible. For example, individual modules or subsystems can be separated into additional modules or subsystems or combined into fewer modules or subsystems. As another example, modules or subsystems can be omitted or supplemented with other modules or subsystems. As another example, functions that are indicated as being performed by a particular device, module, or subsystem may instead be performed by one or more other devices, modules, or subsystems. Although some examples in the present disclosure include descriptions of devices comprising specific hardware components in specific arrangements, techniques and tools described herein can be modified to accommodate different hardware components, combinations, or arrangements. Further, although some examples in the present disclosure include descriptions of specific usage scenarios, techniques and tools described herein can be modified to accommodate different usage scenarios. Functionality that is described as being implemented in software can instead be implemented in hardware, or vice versa.

Many alternatives to the techniques described herein are possible. For example, processing stages in the various techniques can be separated into additional stages or combined into fewer stages. As another example, processing stages in the various techniques can be omitted or supplemented with other techniques or processing stages. As another example, processing stages that are described as occurring in a particular order can instead occur in a different order. As another example, processing stages that are described as being performed in a series of steps may instead be handled in a parallel fashion, with multiple modules or software processes concurrently handling one or more of the illustrated processing stages. As another example, processing stages that are indicated as being performed by a particular device or module may instead be performed by one or more other devices or modules.

Many alternatives to the user interfaces described herein are possible. In practice, the user interfaces described herein may be implemented as separate user interfaces or as different states of the same user interface, and the different states can be presented in response to different events, e.g., user input events. The user interfaces can be customized for different devices, input and output capabilities, and the like. For example, the user interfaces can be presented in different ways depending on display size, display orientation, whether the device is a mobile device, etc. The information and user interface elements shown in the user interfaces can be modified, supplemented, or replaced with other elements in various possible implementations. For example, various combinations of graphical user interface elements including text boxes, sliders, drop-down menus, radio buttons, soft buttons, etc., or any other user interface elements, including hardware elements such as buttons, switches, scroll wheels, microphones, cameras, etc., may be used to accept user input in various forms. As another example, the user interface elements that are used in a particular implementation or configuration may depend on whether a device has particular input and/or output capabilities (e.g., a touchscreen). Information and user interface elements can be presented in different spatial, logical, and temporal arrangements in various possible implementations.

While illustrative embodiments have been illustrated and described, it will be appreciated that various changes can be made therein without departing from the spirit and scope of the invention.

The embodiments of the invention in which an exclusive property or privilege is claimed are defined as follows:

1. A computer-implemented method for providing coaching feedback for a human learner, the method comprising, by a computer system:
receiving video input including video of the human learner;
feeding the video input to a video analysis engine;
using the video analysis engine to extract video features from the video input based on output of video assessment tasks including person detection, person identification, action detection, and emotion detection;
feeding the extracted video features to an artificial intelligence scoring engine implementing a multi-task learning neural network; and
obtaining an automated score for the video input from the artificial intelligence scoring engine, wherein the automated score is based on the extracted video features and a scoring rubric that has been previously learned by the artificial intelligence scoring engine.

2. The method of claim 1 further comprising:
receiving voice input from the human learner;
feeding the voice input to a context-aware natural language processing engine;
using the context-aware natural language processing engine to perform a role detection task on the voice input.

3. The method of claim 1 further comprising:
receiving voice input from the human learner;
feeding the voice input to a context-aware natural language processing engine;
using the context-aware natural language processing engine to extract features from the voice input, the extracted features including one or more of fluency score, pronunciation score, grammar score, coherence score, and vocabulary score;
feeding the extracted features to an artificial intelligence scoring engine; and
obtaining an automated score for the voice input from the artificial intelligence scoring engine, wherein the automated score is based on the extracted features and a scoring rubric that has been previously learned by the artificial intelligence scoring engine.

4. The method of claim 3, wherein the artificial intelligence scoring engine includes a reinforcement learning agent.

5. The method of claim 4, wherein the reinforcement learning agent uses a Q-learning algorithm.

6. The method of claim 3, wherein the extracted features include the vocabulary score, and wherein calculation of the vocabulary score comprises using term frequency-inverse document frequency (TF-IDF) analysis.

7. The method of claim 3 further comprising:
performing topic extraction on the voice input;
performing polarity analysis on the voice input;
analyzing the results of the topic extraction and the polarity analysis in combination with the coherence score to measure connectedness between sentences in the voice input, wherein the calculation of the coherence score comprises using distribution of cosine similarity between sentences.

8. The method of claim 3, wherein the extracted features include the pronunciation score, and wherein the calculation of the pronunciation score comprises using a goodness of pronunciation (GOP) algorithm in combination with a linear support vector machine (SVM).

9. The method of claim 3, wherein the extracted features include the grammar score, and wherein calculation of the grammar score comprises comparing raw text with grammar corrected text and identifying differences between the raw text and the grammar corrected text.

10. The method of claim 3, wherein the extracted features further include a sentiment score.

11. A computer-implemented method comprising, by a computer system:
receiving voice input;
feeding the voice input to a context-aware natural language processing engine;
using the context-aware natural language processing engine to extract features from the voice input, the extracted features including fluency score, pronunciation score, grammar score, coherence score, and vocabulary score;
feeding the extracted features to an artificial intelligence scoring engine; and
obtaining an automated score for the voice input from the artificial intelligence scoring engine, wherein the automated score is based on the extracted features and a scoring rubric that has been previously learned by the artificial intelligence scoring engine.

12. The method of claim 11, wherein the artificial intelligence scoring engine maps the extracted features into the scoring rubric with dynamic weight adjustment using a deep neural network with reinforcement learning.

13. The method of claim 11, wherein the artificial intelligence scoring engine includes a reinforcement learning agent that uses a Q-learning algorithm.

14. The method of claim 11, wherein calculation of the vocabulary score comprises using term frequency-inverse document frequency (TF-IDF) analysis.

15. The method of claim 11, wherein the calculation of the coherence score comprises using distribution of cosine similarity between sentences.

16. The method of claim 11, wherein the calculation of the pronunciation score comprises using a goodness of pronunciation (GOP) algorithm in combination with a linear support vector machine (SVM).

17. The method of claim 11, wherein the extracted features further include a sentiment score.

18. The method of claim 11, further comprising:
receiving video input including video of a human learner;
feeding the video input to a video analysis engine;
using the video analysis engine to extract video features from the video input, the extracted video features being based on output from one or more of the following tasks: emotion detection, posture detection, action detection, head pose detection, role identification;
feeding the extracted video features to the artificial intelligence scoring engine; and
obtaining a second automated score for the video input from the artificial intelligence scoring engine, wherein the second automated score is based on the extracted video features and a second scoring rubric that has been previously learned by the artificial intelligence scoring engine.

19. A non-transitory computer-readable medium having stored thereon computer-executable instructions configured to cause a computer system to perform steps comprising:
receiving voice input;
feeding the voice input to a context-aware natural language processing engine;
using the context-aware natural language processing engine to extract features from the voice input, the extracted features including fluency score, pronunciation score, grammar score, and coherence score;
feeding the extracted features to an artificial intelligence scoring engine; and
obtaining an automated score for the voice input from the artificial intelligence scoring engine, wherein the automated score is based on the extracted features and a scoring rubric that has been previously learned by the artificial intelligence scoring engine.

20. The non-transitory computer-readable medium of claim 19, wherein the artificial intelligence scoring engine maps the extracted features into the scoring rubric with dynamic weight adjustment using a deep neural network with reinforcement learning.
